(19) United States
(12) Patent Application Publication
(10) Pub. No.: US 2007/0060297 A1
(43) Pub. Date: Mar. 15, 2007

(54) Collection and Redemption Gaming Machines and Methods

(75) Inventors: Marvin A. Hein, Las Vegas, NV (US); Kimberly Cohn, Las Vegas, NV (US)

Correspondence Address: BALLY GAMING INC., 6601 S. BERMUDA ROAD, LAS VEGAS, NV, 89119, US

(73) Assignee: BALLY GAMING, INC., Las Vegas, NV (US)

(21) Appl. No.: 11/530,121

(22) Filed: Sep. 8, 2006

Related U.S. Application Data
(60) Provisional application No. 60/715,944, filed on Sep. 10, 2005.

(51) Int. Cl. A63F 13/00

(52) U.S. Cl. 463/20

(57) ABSTRACT

Collection and redemption gaming machines and methods of operating such machines are disclosed. A collectable symbol accumulator accumulates a plurality of collectable symbols according to certain criteria. At a time based on other criteria, the collectable symbols are subsequently offered for redemption by a player for an award.

### RELATED APPLICATIONS

This application claims priority from Provisional Application No. 60/715,944 filed on Sep. 10, 2005, hereby incorporated by reference.

### FIELD OF THE INVENTION

The present invention is directed to gaming machines and methods and, more particularly, to gaming machines and methods that provide a collection and redemption bonus.

### BACKGROUND OF THE INVENTION

In the prior art, various types of gaming machines have been developed with different features to captivate and maintain player interest. For example, gaming machines may include flashing displays, lighted displays, or sound effects to capture a player's interest in a gaming device. In general, a gaming machine allows a player to play a game in exchange for a wager. Depending on the outcome of the game, the player may be entitled to an award which is paid to the player by the gaming machine, normally in the form of currency or game credits.

Another important feature of maintaining player interest in a gaming machine includes providing the player with many opportunities to win awards, such as cash or prizes. For example, in some slot machines, the display windows show more than one adjacent symbol on each reel, thereby allowing for multiple-line betting. Other types of slot machines have been developed that offer second-chance or bonus games that provide players with additional opportunities to win, such as with a bonus wheel. Some gaming machines offer a player the opportunity to win millions of dollars by providing progressive jackpots; while some gaming machines include bonus games that are used to entice and enhance player excitement. For instance, bonus features of various types have been employed to reward players above the amounts normally awarded on a standard game pay schedule. Generally, such bonus features are triggered by predetermined events such as one or more appearances of certain combinations of indicia in the “base game”. In order to stimulate interest, bonus awards are typically set to occur at a gaming machine on a statistical cycle based upon the number of base game plays.

While gaming machines including bonus games have been very successful, there remains a need for gaming machines that provide a player with enhanced excitement and increased opportunity of winning.

### SUMMARY OF THE INVENTION

In accordance with one aspect of the present invention, a gaming machine includes a central processing unit operatively coupled to a set of player-operated controls and a memory configured to store a wagering game program operable by the central processing unit in accordance with the player-operated controls. The machine further includes an accumulator incrementable by one or more units based on predetermined criteria and a display device controlled by the central processing unit and configured to display a message indicating a predefined short-term opportunity for a player to redeem the incremented units.

In accordance with another aspect of the invention, a gaming machine includes a central processing unit operatively coupled to a set of player-operated controls and a memory configured to store a wagering game program operable by the central processing unit in accordance with the player-operated controls. The machine further includes an accumulator incrementable by one or more units based on predetermined criteria and a display device controlled by the central processing unit. Additionally, the machine includes a cash out interface activatable by the player and a confirmation message displayable on the display device upon the player activating the cash out interface.

In accordance with one embodiment of the invention, a method of operating a gaming machine includes the steps of accepting a wager of one or more bet units; initiating play of a game; randomly selecting one of a set of possible outcomes of the game, the set of possible outcomes including a winning subset of outcomes; incrementing an accumulator by one or more units in the event predetermined criteria are satisfied; further incrementing the accumulator by one or more units upon subsequent satisfaction of the predetermined criteria; and displaying an opportunity to redeem incremented units for an award or prize upon achieving a trigger level, the redemption opportunity expiring upon a player accepting or declining the redemption opportunity.

In accordance with yet another embodiment of the invention, a method of operating a gaming machine includes the steps of accepting a wager of one or more bet units; initiating play of a game; randomly selecting one of a set of possible outcomes of the game, the set of possible outcomes including a winning subset of outcomes; incrementing an accumulator by one or more units in the event predetermined criteria are satisfied; further incrementing the accumulator by one or more units upon subsequent satisfaction of the predetermined criteria; displaying a confirmation message when the player attempts to cash out; and allowing the player to continue play in lieu of cashing out.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a perspective view of a gaming machine including a collectable symbol accumulator in accordance with one aspect of the present invention.

FIG. 2 is a block diagram of the physical and logical components of the gaming machine of FIG. 1.

FIGS. 3a and 3b are display images associated with a game of one embodiment of the invention.

FIG. 4 is a display image of an offer to the player to redeem collectable symbols for bonus credits and free game play in accordance with one aspect of the invention.

FIG. 5 is a functional block diagram depicting the acts associated with extending an offer to a player to redeem collectable symbols for bonus credits and free game play in accordance with one embodiment of the present invention.

FIG. 6 is a functional block diagram depicting the acts of one aspect of the present invention associated with reminding a player of any accumulated units when the cash out button is pressed.

FIG. 7 is a representation of a display screen presenting a confirmation request to the player in accordance with one embodiment of the invention.

FIG. 8 is a schematic block diagram showing the hardware elements of a networked gaming system in accordance with one aspect of the present invention.

### DETAILED DESCRIPTION OF THE INVENTION

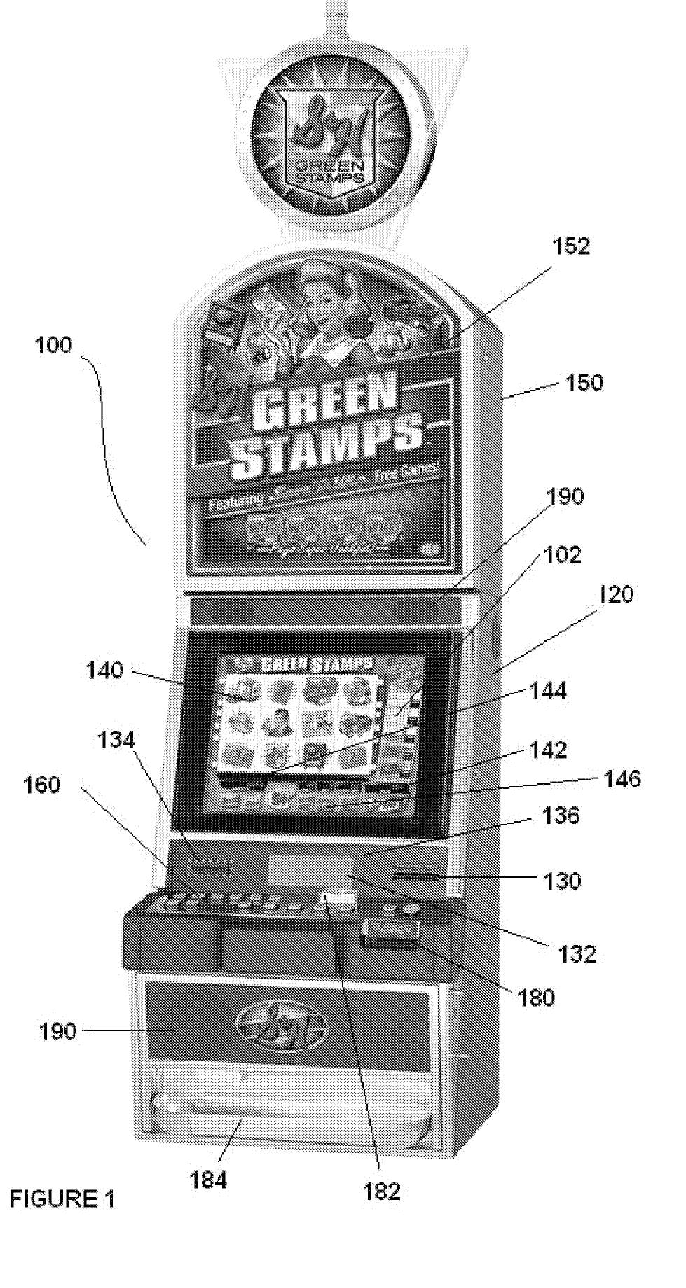

In accordance with one aspect of the present invention, FIG. 1 illustrates a gaming machine 100 including accumulator 102, cabinet housing 120, base game display 140, player-activated buttons 160, player tracking panel 136, bill/voucher acceptor 180 and one or more speakers 190. Cabinet housing 120 is a self-standing unit that is generally rectangular in shape and may be manufactured with reinforced steel or other rigid materials which are resistant to tampering and vandalism. Cabinet housing 120 houses a processor, circuitry, and software (not shown) for receiving signals from the player-activated buttons 160, operating the games, and transmitting signals to the respective displays and speakers. Any shaped cabinet may be implemented with any embodiment of gaming machine 100 so long as it provides access to a player for playing a game. For example, cabinet 120 may comprise a slant-top, bar-top, or table-top style cabinet. The operation of gaming machine 100 is described more fully below.

The plurality of player-activated buttons 160 may be used for various functions such as, but not limited to, selecting a wager denomination, selecting a game to be played, selecting a wager amount per game, initiating a game, or cashing out money from gaming machine 100. Buttons 160 function as input mechanisms and may include mechanical buttons, electromechanical buttons or touch screen buttons. Optionally, a handle (not shown) may be rotated by a player to initiate a game.

In other embodiments, buttons 160 may be replaced with various other input mechanisms known in the art such as, but not limited to, a touch screen system, touch pad, track ball, mouse, switches, toggle switches, or other input means used to accept player input. For example, one input means is a universal button module as disclosed in U.S. application Ser. No 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of pay lines to play in a game and the number of credits to bet per line.

Cabinet housing 120 may optionally include top box 150 which contains “top glass” 152 comprising advertising or payout information related to the game or games available on gaming machine 100. Player tracking panel 136 includes player tracking card reader 134 and player tracking display 132. Voucher printer 130 may be integrated into player tracking panel 136 or installed elsewhere in cabinet housing 120 or top box 150.

Game display 140 presents a game of chance wherein a player receives one or more outcomes from a set of potential outcomes. For example, one game of chance is a video slot machine game, an example of which is entitled “S & H Green Stamps,” having a stamp collecting theme. The S & H Green Stamps game features a basic slot machine game with four simulated spinning reels, a collectable symbol accumulator in the form of stamp books and a bonus game redemption offer triggered by achieving a qualifying milestone in the form of a completed book of stamps. It will be appreciated, however, that the game may be implemented with themes and collectable symbols other than stamps. For example, in one embodiment of the invention, further described below, the player accumulates golden monkeys.

In other aspects of the invention, gaming machine 100 may present a mechanical reel slot machine, a video poker game, a video keno game, a lottery game, a bingo game, a Class II bingo game, a roulette game, a craps game, a blackjack game, a mechanical or video representation of a wheel game or the like. In alternative embodiments, it may further be appreciated that games of skill or games of chance involving some player skill may be implemented with gaming machine 100.

Mechanical or video/mechanical embodiments may include game displays such as mechanical reels, wheels, or dice as required to present the game to the player. In video/mechanical or pure video embodiments, game display 140 is, typically, a CRT or a flat-panel display in the form of, but not limited to, liquid crystal, plasma, electroluminescent, vacuum fluorescent, field emission, or any other type of panel display known or developed in the art. Game display 140 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 140 preferably includes a touch screen or touch glass system (not shown) and presents player interfaces such as, but not limited to, credit meter 144, win meter 142 and touch screen buttons 146. An example of a touch glass system is disclosed in U.S. Pat. 6,942,571, entitled “Gaming Device with Direction and Speed Control of Mechanical Reels Using Touch Screen,” which is hereby incorporated by reference.

Game display 140 may also present information such as, but not limited to, player information, advertisements and casino promotions, graphic displays, news and sports updates, or even offer an alternate game. This information may be generated through a host computer networked with gaming machine 100 on its own initiative or it may be obtained by request of the player using either one or more of the plurality of player-activated buttons 160; the game display itself, if game display 140 comprises a touch screen or similar technology; buttons mounted about game display 140 (not shown) which may permit selections such as those found on an ATM machine, where legends on the screen are associated with respective selecting buttons; or any player input device that offers the required functionality.

Cabinet housing 120 incorporates a single game display 140. However, in alternate embodiments, cabinet housing 120 or top box 150 may house one or more additional displays or components (not shown) used for various purposes including additional game play screens, animated “top glass,” progressive meters or mechanical or electromechanical devices such as, but not limited to, wheels, pointers or reels. The additional displays may or may not include a touch screen or touch glass system.

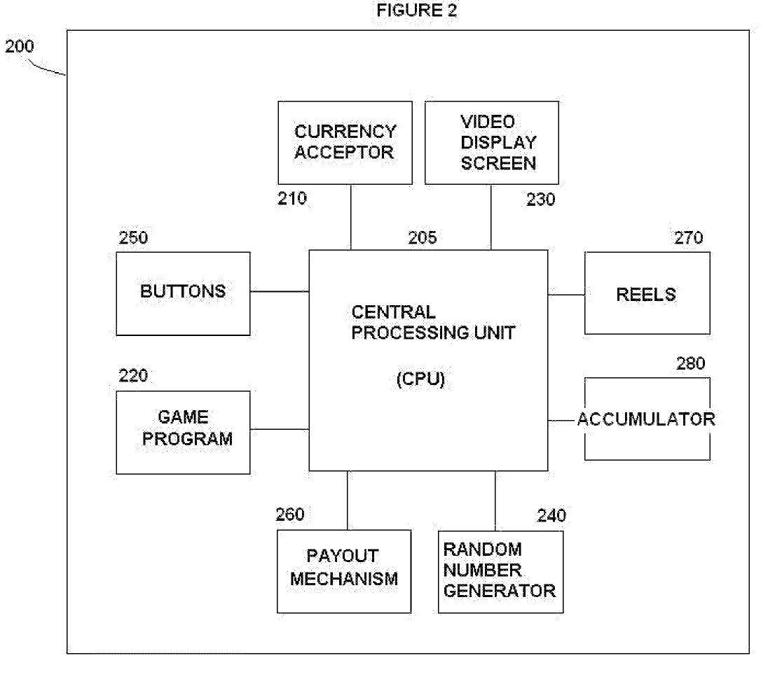

In accordance with one embodiment of the present invention, FIG. 2 is a block diagram showing the interconnection of physical and logical components 200 of gaming machine 100. Currency acceptor 210 is typically connected to central processing unit (“CPU”) 205 by a serial connection such as RS-232 or USB. CPU 205 executes game program 220 that causes video display screen 230 to display a game that includes a plurality of simulated indicia-bearing reels 270. In one embodiment, game program 220 is a collection and redemption game such as S & H Green Stamps, described further below.

When a player has inserted a form of currency such as, for example and without limitation, paper currency, coins or tokens, cashless tickets or vouchers, electronic funds transfers or the like into currency acceptor 210, a signal is sent to CPU 205 which, in turn, assigns an appropriate number of credits for play. The player may further control the operation of gaming machine 100, for example, to select the number of pay lines to play and the amount to wager via electromechanical or touchscreen buttons 250. The game starts in response to the player pulling a lever or pushing one of buttons 250, the detection of which causes CPU 205 to spin reels 270 displayed on video display screen 230. Random number generator 240 responds to instructions from CPU 205 to provide a randomly selected stop position for each reel. CPU 205 then stops the reels according to the predetermined stop positions to display a plurality of reel indicia on video display screen 230. The set of possible outcomes includes a subset of outcomes related to the accumulation of collectable symbols or tokens. In the event the displayed outcome is a member of this subset, accumulator 280 is incremented by one or more units. If the value of accumulator 280 is equal to one of a predetermined set of milestones, CPU 205 under control of game program 220 presents an offer to play a bonus game on video display screen 230. The player may accept or decline the offer by way of electromechanical or touchscreen buttons 250. If the player accepts the offer, game program 220 presents a bonus game for play on video display 230. If the player declines the offer, the offer is removed from video display 230.

In various embodiments of gaming machine 100, game program 220 is stored in a memory device (not shown). By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with gaming machine 100 are stored in the same or a separate memory device (not shown).

Predetermined payout amounts for certain combinations of reel indicia and bonus game outcomes are stored as part of game program 220. Such payout amounts are, in response to instructions from CPU 205, provided to the player in the form of coins, credits or currency via payout mechanism 260, which may be one or more of a credit meter, a coin hopper, a voucher printer, an electronic funds transfer protocol or any other payout means known or developed in the art.

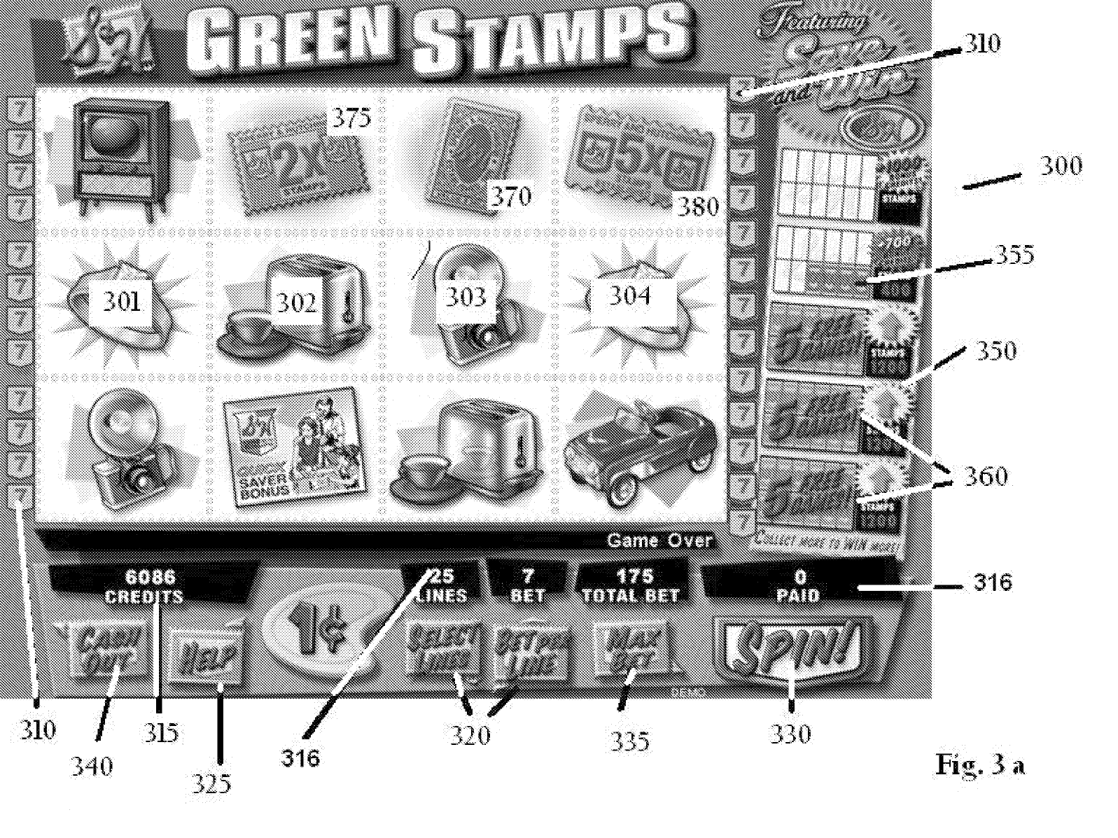

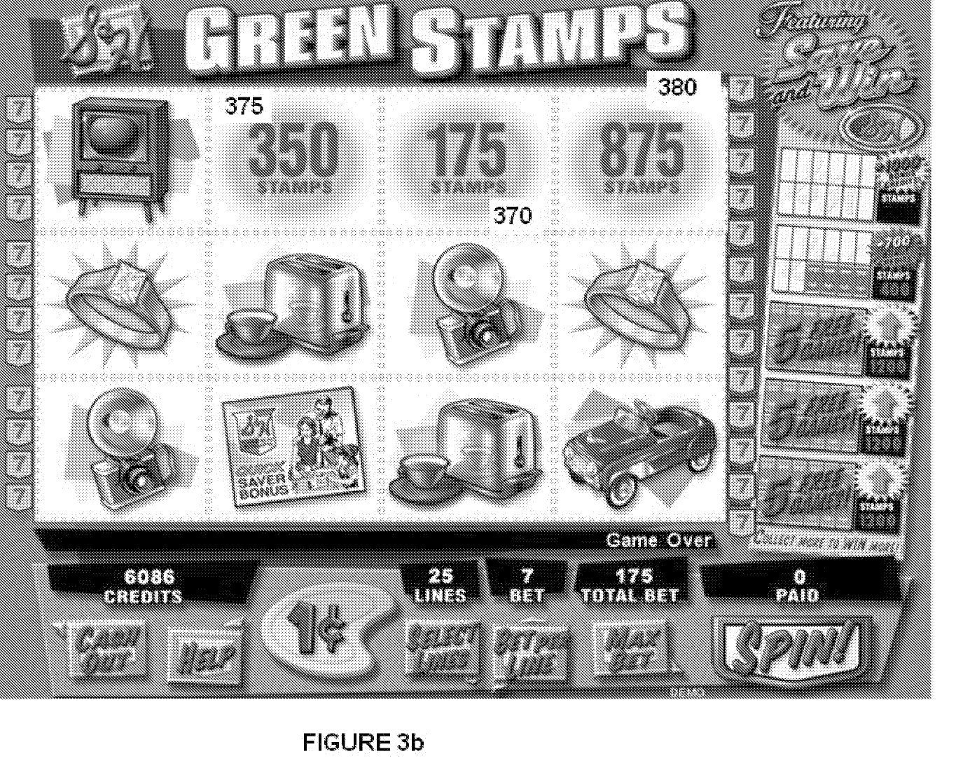

Referring to FIG. 3a, in accordance with one aspect of the invention, an S & H Green Stamps game 300 is implemented using four simulated spinning reels 301-304. Each of twenty-five pay line patterns (not shown) passes through one indicium on each of the four reels 301-304. The player selects the number of played pay lines and the number of credits or coins wagered on each line using touch screen selection buttons 320. The player may also collect the balance of his credits by pressing CASH OUT button 340.

Credit meter 315 displays the player's current credit balance, while other meters 316 may display the number of lines selected for play, the number of credits or coins selected for wager on each pay line, the total bet size and the last amount paid to the player. Other meters 316 containing other information may be displayed. The amount wagered on each pay line is additionally indicated by a bet tag 310 corresponding to each pay line. In the example shown, seven credits have been wagered on each of the twenty-five pay lines.

The player initiates game play by pressing SPIN button 330. Alternately, the player may simultaneously select all pay lines at the maximum number of coins or credits allowed per line by pressing MAX BET touch screen button 335. Buttons on the gaming machine control panel may be used instead of the touch screen buttons to perform the actions described here without deviating from the scope of the invention. A video representation of reels 301-304 is made to spin and stop the reels in their predetermined stop positions and then indicate whether the stop positions of the reels resulted in a winning game outcome.

Winning outcomes may be indicated on a pay table (not shown) that may be accessible through HELP button 325. In alternate embodiments, the pay table may be presented on a second animated or still video or a static printed display attached to the gaming machine (i.e. a “pay glass”). A winning combination, for example, could be three or more camera indicia adjacent to one another on an active pay line. For each winning combination, the game device awards the player the award in the pay table, adjusted as necessary based on the number of credits wagered on the pay line on which the win occurred. Some video representations of pay tables may factor in the amount of the player's wager and no additional award adjustment is required.

In various embodiments, winning combinations may be evaluated across adjacent reels from left-to-right, from right-to-left or both. Additional winning combinations may be awarded when certain indicia do not necessarily accumulate adjacently on a pay line, but rather, appear anywhere on the reels (i.e., “scatter pays”). In addition, “wild” indicia may be used to complete winning combinations. Some “wild” indicia may also cause completed winning combinations to be result in pay amounts in excess of the normal winning combination by way of multiplication or addition, for example, a wild doubler symbol may be used.

In the exemplar S & H Green Stamps game, the following win evaluation rules are presented as an example, not intended to be limiting in any way. All pays, except scatter pays, are adjacent and are evaluated from left to right on an active pay line starting with the leftmost reel. Only the highest win is paid per line played. Line pays are multiplied by the number of credits bet on the pay line. One or more wild indicia in a winning combination on an active pay line substitutes for all indicia except the “1 Stamp”, “2× Stamps”, “5×Stamps”, “Saver Book” indicia. Four adjacent “Saver book” indicia on an active pay line award a Quick Saver Bonus Feature. The player then selects one of the four displayed “Saver book” indicia to receive a bonus award. Bonus award ranges from 10 to 500 times the line bet on the triggering pay line.

Additionally, in the Save and Win Free Games Bonus Feature, 200 Green Stamps are required to fill one stamp book. Redeemed stamp books award free games and bonus credits as follows: 1 stamp book=5 free games at 10×normal pay and 100 bonus credits; 2 stamp books=10 free games at 10×normal pay and 250 bonus credits; 3 stamp books =15 free games at 10×normal pay and 450 bonus credits; 4 stamp books=20 free games at 10×normal pay and 700 bonus credits; 5 stamp books=25 free games at 10×normal pay and 1000 bonus credits. All free games are played with maximum pay lines at one credit bet per pay line. Free games and bonus credits are awarded at the time of player redemption. The Free Games Bonus Feature will automatically begin when five or more full stamp books are accumulated. Any remaining Green Stamps are carried over when the player returns to normal game play. The free game reels differ from the base game reels in that the “1 Stamp,” “2 Stamps,” “5 Stamps,” and “Saver Book” indicia are not available during free games. All other indicia in the free games pay as described in the base game pay table.

Furthermore, Green Stamps have no cash value. Upon pressing the “collect” button, any accumulated Green Stamps will remain on the game. Optimal strategy is to save Green Stamps until five or more stamp books are filled. In the event that more than five stamp books are filled, optimal strategy is to play 25 free games and continue saving green stamps until the next set of five stamp books is filled.

Continuing with FIG. 3a and as described above, in addition to the representation of the slot machine base game, game 300 displays collectable symbol accumulator 350 that increments in units that take the form of collectable symbols or tokens such as stamps 355 organized in five stamp books 360. Among the plurality of base game outcomes is at least one award of one or more stamps 355 into open spaces in stamp books 360. Each stamp book 360 of collectable symbol accumulator 350 can accumulate 1,200 stamps, thus each open rectangle in stamp books 360 represents 100 stamps. The player can see the total number of stamps saved by totaling the stamp counts displayed on each stamp book 360.

In the exemplar embodiment, S & H Green Stamps are awarded any time one or more “1 Stamp,” “2 Stamps,” or “5 Stamps” indicia appear in any position on the reels. S & H Green Stamps accumulate during normal game play as follows: “1 Stamp” awards 1× the total bet Green Stamps, “2 Stamps” awards 2× the total bet Green Stamps and “5 Stamps” awards 5× the total bet Green Stamps.

By way of example and not intended to be limiting in any way, the indicia shown on FIG. 3a include three scattered stamp indicia that will result in collectable symbol accumulation. Stamp indicium 370 on the third reel awards the player one stamp 355 for each of the 175 credits wagered on the game. Stamp indicium 375 provides a multiplier factor of two times the “normal” number of stamps and, thus, in this example, awards the player 350 stamps. Similarly, again by example only, stamp indicium 380 awards the player five times the “normal” number of stamps, or 875 stamps. Turning briefly to FIG. 3b, in accordance with one aspect of the present invention, representations of stamp indicia 370, 375 and 380 are shown modified to indicate the number of stamps actually awarded to the player for each of the original stamp indicia based on the number of credits wagered.

Continuing with FIG. 3a, in the S & H Green Stamps game, each full stamp book 360 may be redeemed for 5 free games. Each time a book 360 is filled with stamps 355, the player is offered an opportunity to redeem them. If the player chooses to play the free games when offered, he is also awarded a bonus value in the form of credits. For example, the bonus may be awarded as shown: 1 book may be redeemed for 5 free games plus 100 credits, 2 books may be redeemed for 10 free games plus 250 credits, 3 books may be redeemed for 15 free games plus 450 credits, 4 books may be redeemed for 20 free games plus 700 credits and 5 books may be redeemed for 25 free games plus 1000 credits.

In the example shown above, the expected value of each bonus level increases the longer the player chooses to save stamps 355. One play strategy is to continue playing until the player reaches five full books 360. Playing five books 360 has a higher expected value than playing one book 360 five times. In other words, redeeming 25 free games plus 1000 bonus credits once has a higher expected value than redeeming 5 free games plus 100 credits five times, since the latter only equates to 25 free games plus 500 bonus credits. This is an example only; the expected value at each bonus offer milestone could remain constant or decrease the longer the player saves stamps.

Collectable symbols in the form of stamps may be awarded according to a formula, for example, as the number of scattered stamp indicia times the total wager amount. For example, a single S & H Green Stamp indicium 370 appearing anywhere on the reels with a single credit wagered would add one stamp 355 to the next non-full stamp book 360. Furthermore, a single S & H Green Stamp indicium with 25 credits bet would add 25 stamps 355 to the stamp book 360 being filled. Given the distribution of S & H Green Stamps indicia on the reels, in one embodiment of the invention and based on a 125-credit total bet, a full book of stamps would accumulate every 21 spins. In another embodiment, when all available books of stamps have been filled, the bonus feature is forced. For example, a 125-credit player who does not redeem books of stamps when first filled would be forced to redeem them after approximately 105 spins and be awarded at least 25 free games plus 1000 bonus credits.

In the example above, it can be seen that the more wagered per play, the faster the player reaches a bonus opportunity. While a player with only a 25-credit total bet would fill a stamp book 360 every 106 plays on average, significantly, a 250-credit total bet player would fill a book every 10 plays on average. At a 250-credit total bet, there is also the possibility of a sixth book 360 since the player can earn enough stamps 355 in a single spin to fill the fifth book 360 plus one additional book 360. If that happens, the player is forced to play 25 free games plus 1000 credits, but can, in the same bonus round, also choose to redeem the sixth book for 10 free games plus 100 credits, consistent with having collected a first book 360 in the next series of five books. In this case, one strategy is to not redeem the sixth book and continue collecting books until the next set of five books 360 is reached, however, this strategy also assumes that the player has unlimited time and financial resources to play the game. The elements of individual player choice and strategy contribute to the appeal of the various embodiments of the invention.

In other embodiments of the present invention, collectable symbols may accumulate based on other types of game outcomes including, but not limited to, awarding units when certain indicia appear on a pay line, when certain indicia are scattered, when no indicia of a certain type appear, or when a certain winning combination occurs. Other award rules may apply in other embodiments. For example, collectable symbol awards may be issued periodically based on the number of games played or based on random criteria other than game outcome (i.e. “mystery” awards).

Upon achieving a milestone of completing a full book during normal game play, the player is given the choice to play the free games and bonus credits associated with his total balance of completed stamp books, or to keep saving S & H Green Stamps until one or more additional stamp books are filled. It should be noted that a particular stamp award may complete one stamp book 360 and partially fill another stamp book 360.

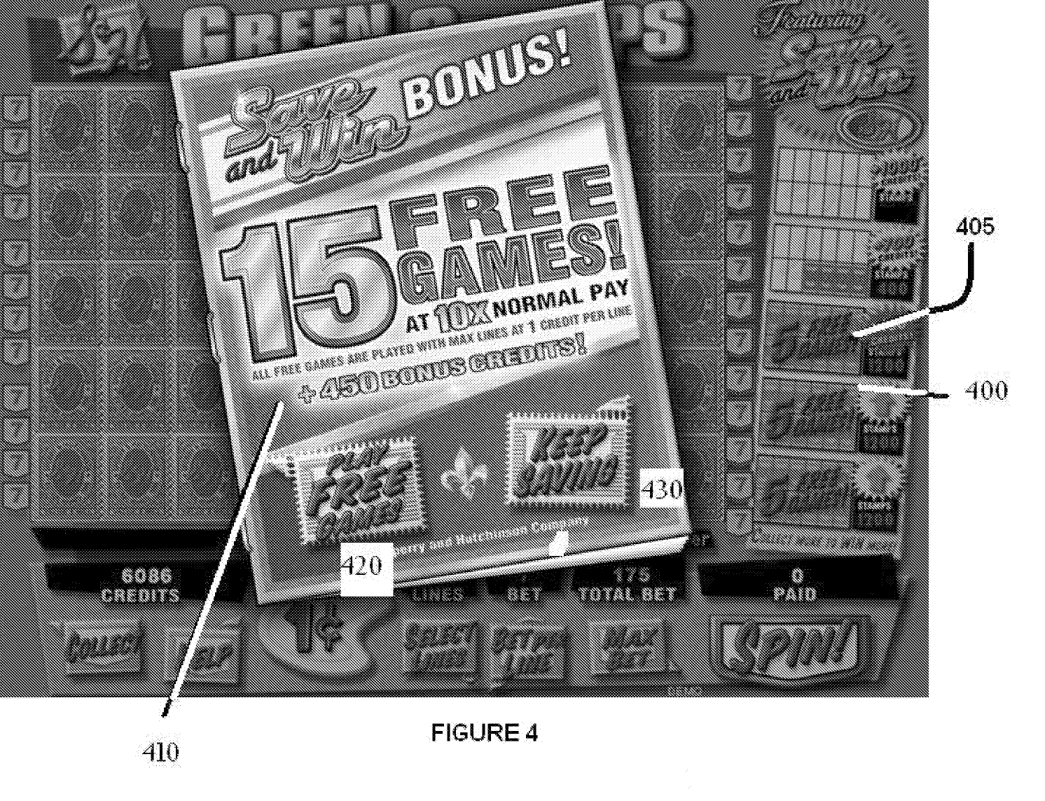

Referring now to FIG. 4, a display image 400 of an offer to the player to redeem collectable symbols for bonus credits and free game play in accordance with one aspect of the invention is shown. A third book of stamps 405 has just been completed, as shown in collectable symbol accumulator 400. The player has been presented with message 410, announcing this event and presenting the option to play the free games immediately by pressing touch screen button 420, or to decline bonus game play in favor of continued saving by pressing touch screen button 430. When the player elects to play the free games by pressing touch screen button 420, the free games and bonus credits awarded will be based on the number of completed stamp books 360 (FIGS. 3a, b). Any non-redeemed partial books 360 of S & H Green Stamps 355 are retained in the collectable symbol accumulator 350 when the player returns to normal game play. If the player chooses not to play free games and collect bonus credits when offered, the offer immediately expires and the player continues saving S & H Green Stamps until the next stamp book 360 is filled, at which time an offer is presented again.

In the illustrated embodiment, the awarding of increasingly large additional bonus credits for each book of stamps redeemed means the longer a player waits to redeem the collectable symbols, the more each collectable symbol increases in value. This encourages a player to remain at his machine longer, while still providing the periodic option to redeem his collectable symbols if his credit meter is low or if he plans to leave his machine soon. In further embodiments, the player may be offered the opportunity to redeem any full books of stamps if the credit meter contains zero credits. This feature prevents the need for the player to abandon earned collectable symbols because he is unable to continue playing to the next redemption offer milestone.

Further variations may occur in other embodiments of the invention. For example, in one embodiment, the player must redeem all of the stamps in the stamp books at one time. Alternately, the player may redeem a selected number of the books at one time. The award for which the stamp books may be redeemed may be in the form of a “second screen” game feature and direct payment of bonus credits. One embodiment awards only game credits. Another embodiment awards either credits or play of a bonus feature. Still another embodiment awards only bonus game play. A further embodiment awards articles such as, but not limited to, vouchers, physical tokens or other media that may be exchanged for cash or non-cash prizes at a location separate from the gaming machine.

Still another embodiment awards either credits or a bonus feature depending on the number of units accumulated at the time of redemption. For example, in a game called Golden Monkey, three collectable golden monkeys may be redeemed for 1200 credits, six golden monkeys may be redeemed for 2500 credits and ten golden monkeys may be redeemed for play of a bonus game. Upon achieving the milestones of collecting either three or six golden monkeys, the player is given the choice to redeem the accumulated monkeys or to keep saving. Upon collecting ten golden monkeys, the bonus game automatically begins and randomly awards one of a plurality of displayed progressive jackpots. The awarded jackpot pool resets to a base amount and begins to progress again with the next game play. In one aspect of the invention, an additional bonus wager is used to fund the progressive jackpot amounts. In other embodiments, a portion of each base game wager funds the bonus game progressive pools or one or more of the progressive pools may be part of a progressive system funded by play on a plurality of gaming machines offering the bonus game and linked by a network, a near-area or a wide-area progressive system.

Any bonus game or awards, known or still to be devised, such as free spins, respins, a poker game, a blackjack game, a roulette game, a spinning wheel game and the like may be offered and redeemed in the redemption manners described above without deviating from the scope of the invention.

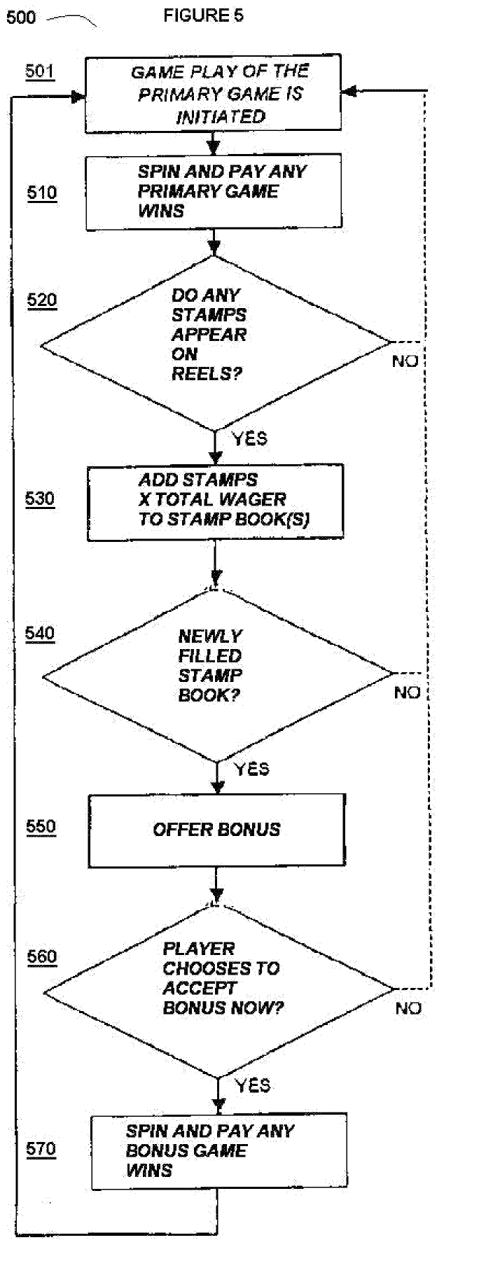

A logical flow diagram generally depicting the steps associated with a method 500 for carrying out a redemption operation of a collection and redemption game in accordance with one aspect of the invention is presented in FIG. 5. The order of actions as shown in FIG. 5 and described below is only illustrative, and should not be considered limiting. For example, the order of the actions may be changed, additional steps may be added or some steps may be removed without deviating from the spirit of the invention.

The player initiates play of the game by inserting currency of some form, selecting the number of lines to play and the number of credits per line and pressing a start switch or button, block 501. The game outcome is presented to the player and he may be awarded a base game award by the game or accumulate collectable symbols in the form of stamps at block 510.

Regardless of win or loss in block 510, it is determined in block 520 whether any S & H Green Stamp indicia appeared on the reels. If no stamps appeared on the reels, processing returns to block 501 and normal play continues on the gaming machine, otherwise processing proceeds to block 530, where a formula is applied to convert the number of stamps appearing on the reels to collectable symbols for saving in the collectable symbol accumulator. For example, the number of stamp indicia may be multiplied by the total number of credits wagered to determine the number of stamps to add to the stamp books.

Continuing with decision block 540, if the number of stamps added to the stamp books has not resulted in a newly filled book, processing returns to block 501 and normal play continues, otherwise a message such as message 410 of FIG. 4 is displayed to inform the player how many full books of stamps 400 have been collected and how many free games and bonus credits may be redeemed, block 550. Also in block 550, as further illustrated by FIG. 4, the player is presented an opportunity to redeem his full stamp books by pressing the PLAY FREE GAMES button 420 or to decline the bonus and retain his collectable symbols for later redemption by pressing the KEEP SAVING button 430.

If the player chooses not to play the bonus at this time by pressing the KEEP SAVING button 430 (FIG. 4), the offer to redeem expires and processing proceeds from block 560 to block 501 and normal play continues on the gaming machine. Otherwise, processing continues from block 560 to block 570, where the player is awarded bonus credits, plays free games and is paid according to their outcomes, after which, processing resumes with normal play at block 501.

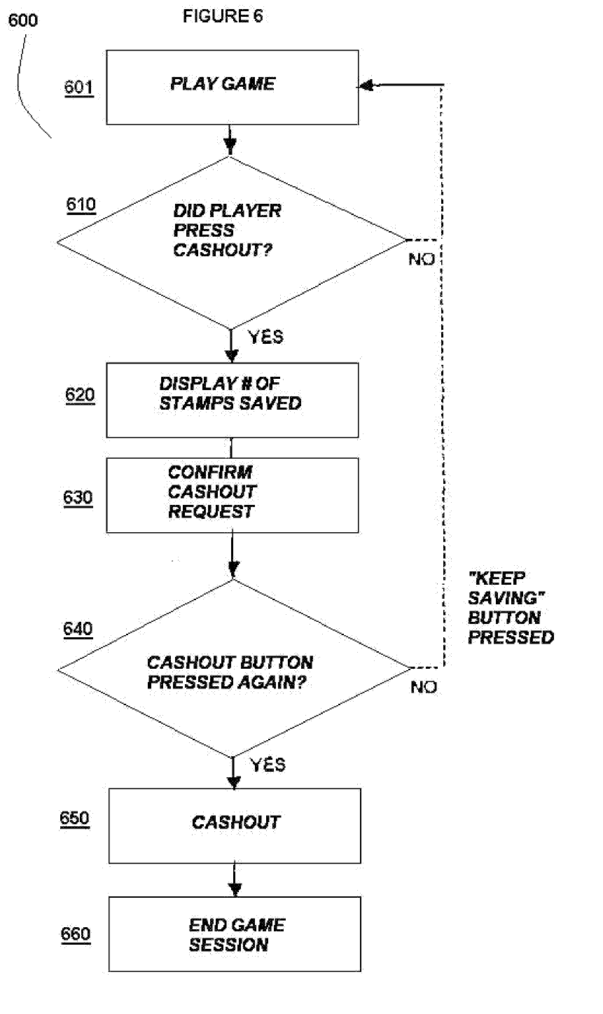

Turning now to FIG. 6, a logical flow diagram generally depicting the steps associated with a method, 600, of the player cashing out in accordance with one aspect of the invention is presented. It will be seen that this invention provides enhanced game play of gaming machines by providing a “warning” when a player is about to abandon accumulated collectable symbols or units and by providing an opportunity to continue playing the game without penalty. The order of actions as shown in FIG. 6 and described below with reference to the S & H Green Stamps game is only illustrative, and should not be considered limiting. For example, the game might have a different theme, such as Golden Monkey (described below), or the order of the actions may be changed, additional steps may be added or some steps may be removed without deviating from the spirit of the invention.

Beginning with block 601, the collection and redemption game of FIGS. 1-5 is played on the gaming machine. For example in a slot primary game, the player initiates play of the slot reels, may be awarded a base game award by the game, may accumulate collectable symbols and may be offered and may play one or more bonus games.

Regardless of win or loss or whether bonus games were played, it is determined at block 610 whether the player pressed the CASH OUT button (340 of FIG. 3a). If the player did not press CASH OUT, processing returns to block 601 and normal play continues on the gaming machine.

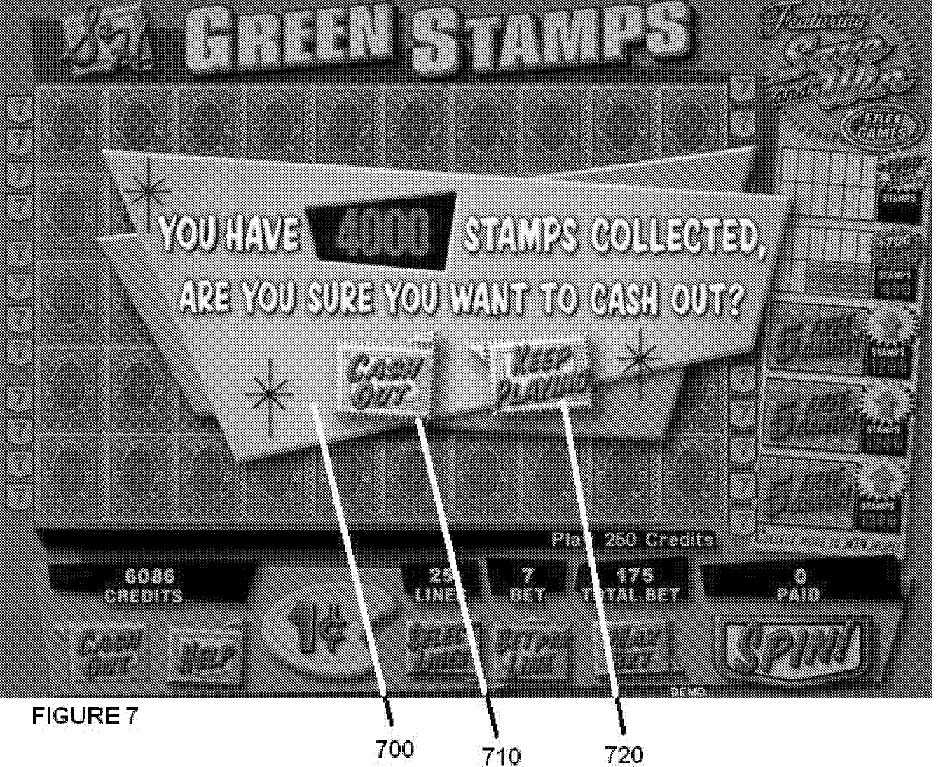

If the player pressed CASH OUT, message 700 of FIG. 7 is displayed at block 620 to inform the player how many stamps he has collected and how many stamps will be abandoned on the machine if he continues to cash out. If the player is close to filling a book when they cash out, a different message (not shown) will appear, telling them how many stamps are needed until the next bonus opportunity.

In either case, the player is requested to confirm his original cash out request by pressing CASH OUT touch screen button 710 (FIG. 7) or cancel his cash out request by pressing KEEP PLAYING touch screen button 720 (FIG. 7) at block 630.

In decision block 640, if the player pressed the KEEP PLAYING button 720 (FIG. 7), normal play continues on the game machine at block 601. Otherwise, the player is paid the balance on credit meter 315 (FIG. 3a) at block 650, then the playing session terminates at block 660.

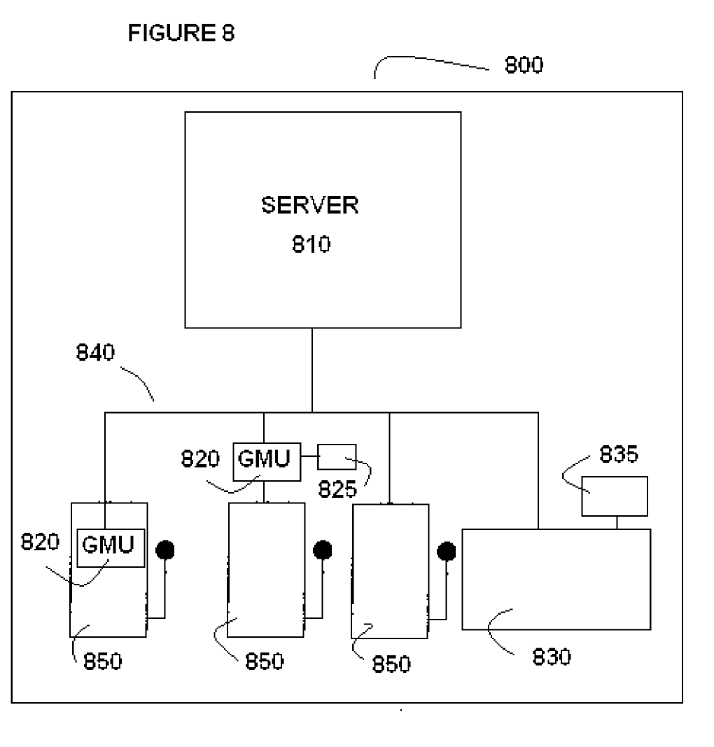

Referring to FIG. 8, in accordance with one aspect of the invention, gaming system 800 includes server 810, gaming machines 850, and network 840 connecting gaming machines 850 to server 810. Additionally, gaming display computer 830 is shown connected to network 840. Server 810 may be selected from a variety of conventionally available servers. The type of server used is generally determined by the platform and software requirements of the gaming system. Examples of suitable servers are an IBM RS6000-based server, an IBM AS/400-based server or a Microsoft Windows-based server, but it should be appreciated that any suitable server may be used. It may also be appreciated that server 810 may be configured as a single “logical” server that comprises multiple physical servers. Gaming machines 850 operate similar to conventional peripheral networked terminals. Gaming machines 850 have a player interface such as a display, a card reader, and selection buttons through which gaming machines 850 interact with a player playing a collection and redemption wagering game. The player interface is used for making choices such as the amount of a bet or the number of lines to bet. Gaming machines 850 also provide information to server 810 concerning activity on gaming machines 850 and provide a communication portal for players with server 810. For example, the player interface may be used for selecting different server-related menu options such as, but not limited to, transferring a specified number of credits from a player account onto the credit meter of the gaming machine, or for transferring credits from the gaming machine to a central player account.

In various embodiments, any of the gaming machines 850 may be a mechanical reel spinning slot machine, video slot machine, video poker machine, keno machine, video blackjack machine, or a gaming machine offering one or more of the above described base games offering a collection and redemption game. Networking components (not shown) facilitate communications across network 840 between the system server 810 and game management units 820 and/or gaming display control computers 830 that control displays for carousels of gaming machines. Game management units (GMU's) 820 connect gaming machines to networking components and may be installed in the gaming machine cabinet or external to the gaming machine. The function of the GMU is similar to the function of a network interface card connected to a desktop personal computer (PC). Some GMU's have much greater capability and can perform such tasks as presenting and playing a collection and redemption game using a display 825 operatively connected to the GMU 820. Displays related to collection and redemption games being played on gaming machines 850 or GMU displays 825 may also be presented on gaming display 835 by gaming display control computer 830. In one embodiment, the GMU 820 is a separate component located outside the gaming machine. Alternatively, in another embodiment, the GMU 820 is located within the gaming machine. Optionally, in an alternative embodiment, one or more gaming machines 850 connect directly to the network and are not connected to a GMU 820.

A gaming system of the type described above also allows a plurality of collection and redemption games to be linked under the control of server 810 for cooperative or competitive play in a particular area, carousel, casino or between casinos located in geographically separate areas. One such system-based embodiment includes a collection and redemption tournament game in which a common system-based collectable symbol accumulator is driven by the results of a plurality of collectable symbol accumulator games played on gaming machines 850. As symbols are accumulated on various gaming machines 850, they also contribute to a common system-based collectable symbol accumulator. When a player decides to redeem accumulated symbols on his gaming machine 850, each gaming machine 850 that contributed symbols to the system-based collectable symbol accumulator may be awarded a prize that may be, but is not necessarily, ranked according to that machine's overall contribution to the shared system-based collectable symbol accumulator.

Another embodiment includes a collectable symbol progressive system which has prizes that may be won by the first player to accumulate a certain number of collectable symbols. For example, one progressive pool might be paid when a first stamp book is filled, one when a second stamp book is filled, and so on. The player would have the option of declining the first progressive associated with a single stamp book in hopes of winning a larger second progressive associated with two full stamp books. In variations of this embodiment, prizes awarded for the successful accumulation of collectable symbols on the individual gaming machines may be supplemented or replaced by additional pools and prizes allocated and awarded for collectable symbol accumulation on a system-based collectable symbol accumulator common to all of the participating gaming machines. Such pools may be funded by a portion of the wagers on each of the participating gaming machines or from other sources such as, but not limited to, promotional monies allocated by a casino.

In another system-based embodiment, the accumulated symbols or units earned by a player during a playing session may be preserved at the termination of play such that the “game state” of the player is maintained from one playing session to another. By way of example and not of limitation, the player may later resume play of gaming machine 850 at the preserved game state by inserting an identifying player card, entering an identification sequence on the player interface, or inserting a voucher or other medium that identifies the particular saved game state. One such means is disclosed in U.S. Pat. 6,923,721, entitled “Apparatus and Method for Maintaining Game State,” which is hereby incorporated by reference, but any means may be used provided the player is able to resume play without loss of accumulated units from one playing session to the next.

One will appreciate that a gaming system may also comprise other types of components, and the above illustrations are meant only as examples and not as limitations to the types of components or games having a collection and redemption element in a gaming system. Additionally, it may further be appreciated that each of the games could be operated on a remote host computer such that a player initiates play with the host computer over a network via the player interface and gaming machine 850 operates the respective gaming and video displays in conjunction with the game whose play is controlled by the remote computer.

Although the description above contains much specificity, it should not be construed as limiting the scope of the invention but as merely providing an illustration of the presently preferred embodiment of the invention. The various embodiments disclosed herein are directed to a system and method for providing an accumulation and redemption game in a gaming device. Embodiments of the system, method and gaming device are illustrated and described herein by way of example only and not by way of limitation. Those skilled in the art will readily recognize various modifications and changes may be made to the invention without departing from the true spirit and scope of the claimed invention as set forth below.

What is claimed is:

1. A gaming machine comprising:
a central processing unit operatively coupled to a set of player-operated controls and a memory configured to store a wagering game program operable by the central processing unit in accordance with the player-operated controls;
an accumulator incrementable by one or more units based on predetermined criteria;
and a display device controlled by the central processing unit and configured to display a message indicating a predefined short-term opportunity for a player to redeem the incremented units.

2. The gaming machine of claim 1 wherein the predefined criteria are based on an outcome of the game program.

3. The gaming machine of claim 1 wherein the predefined criteria are not based on an outcome of the game program.

4. The gaming machine of claim 1 wherein the predefined criteria are based on the number of plays of the game program.

5. The gaming machine of claim 1 wherein the predefined short-term opportunity for a player to redeem the incremented units expires upon the player accepting or declining the opportunity to redeem the incremented units.

6. The gaming machine of claim 1, the display device including an area wherein the accumulator is represented by one or more collectable symbols.

7. The gaming machine of claim 1, further comprising a cash out interface activatable by the player and a confirmation message displayable on the display device upon the player activating the cash out interface.

8. The gaming machine of claim 1 wherein the message is displayed upon the accumulation of one or more predefined quantities of the incremented units.

9. The gaming machine of claim 1 wherein the number of incremented units is multiplicatively dependent upon the size of a wager placed during operation of the game program.

10. The gaming machine of claim 1 wherein the number of incremented units is dependent upon the outcome of the game program.

11. The gaming machine of claim 1 wherein the incremented units are redeemed for credits, the number of credits determined by the number of incremented units.

12. The gaming machine of claim 1 wherein the incremented units are redeemed for an opportunity to play a feature game.

13. The gaming machine of claim 12 further comprising a progressive prize, the progressive prize awardable as a result of the feature game outcome.

14. A gaming machine comprising: a central processing unit operatively coupled to a set of player-operated controls and a memory configured to store a wagering game program operable by the central processing unit in accordance with the player-operated controls; an accumulator incrementable by one or more units based on predetermined criteria; a display device controlled by the central processing unit; a cash out interface activatable by the player and a confirmation message displayable on the display device upon the player activating the cash out interface.

15. The gaming machine of claim 14 wherein the predefined criteria are based on an outcome of the game program.

16. The gaming machine of claim 14 wherein the predefined criteria are not based on an outcome of the game program.

17. The gaming machine of claim 14 wherein the predefined criteria are based on the number of plays of the game program.

18. The gaming machine of claim 14, the display device including an area wherein the accumulator is represented by one or more collectable symbols.

19. The gaming machine of claim 14 wherein the number of incremented units is multiplicatively dependent upon the size of a wager placed during operation of the wagering game program.

20. The gaming machine of claim 14 wherein the number of incremented units is dependent upon the outcome of the game program.

21. The gaming machine of claim 14 wherein the incremented units are redeemed for credits, the number of credits determined by the number of incremented units.

22. The gaming machine of claim 14 wherein the incremented units are redeemed for an opportunity to play a feature game.

23. The gaming machine of claim 22 further comprising a progressive prize, the progressive prize awardable as a result of the feature game outcome.

24. A method of operating a gaming machine, the method including the steps of:
accepting a wager of one or more bet units;
initiating play of a game;
randomly selecting one of a set of possible outcomes of the game, the set of possible outcomes including a winning subset of outcomes;
incrementing an accumulator by one or more units in the event predetermined criteria are satisfied;
further incrementing the accumulator by one or more units upon subsequent satisfaction of the predetermined criteria;
and displaying an opportunity to redeem incremented units for an award or prize upon achieving a trigger level, the redemption opportunity expiring upon a player accepting or declining the redemption opportunity.

25. The method of claim 24 wherein the predefined criteria are based on the selected game outcome.

26. The method of claim 24 wherein the predefined criteria are not based on the selected game outcome.

27. The method of claim 24 wherein the predefined criteria are based on the number of games played.

28. The method of claim 24 including the step of: displaying subsequent redemption opportunities upon achievement of subsequent trigger levels, the subsequent trigger levels corresponding to the accumulation of one or more predefined quantities of the incremented units.

29. The method of claim 24 including the step of multiplying the number of units to be incremented by the number of bet units.

30. The method of claim 24 wherein the number of incremented units is dependent upon the randomly selected outcome.

31. The method of claim 24 including the step of redeeming the incremented units for credits, the number of credits determined by the number of incremented units redeemed.

32. The method of claim 24 including the step of redeeming the incremented units for an opportunity to play a feature game.

33. The method of claim 32 further including the step of paying a progressive prize awardable as a result of the feature game outcome.

34. The method of claim 24 further including the step of displaying a confirmation message when the player attempts to cash out; and allowing the player to continue play in lieu of cashing out.

35. The method of claim 24 further including the step of displaying an opportunity for the player to redeem the incremented units upon losing all wagerable credits.

36. The method of claim 24 further including the step of associating the incremented units with the player and saving the incremented units from one playing session to another.

37. A method of operating a gaming machine, the method including the steps of:
accepting a wager of one or more bet units; initiating play of a game; randomly selecting one of a set of possible outcomes of the game, the set of possible outcomes including a winning subset of outcomes; incrementing an accumulator by one or more units in the event predetermined criteria are satisfied; further incrementing the accumulator by one or more units upon subsequent satisfaction of the predetermined criteria; displaying a confirmation message when the player attempts to cash out; and allowing the player to continue play in lieu of cashing out.

38. The method of claim 37 wherein the predefined criteria are based on the selected game outcome.

39. The method of claim 37 wherein the predefined criteria are not based on the selected game outcome.

40. The method of claim 37 wherein the predefined criteria are based on the number of games played.

41. The method of claim 37 including the step of: displaying subsequent redemption opportunities upon achievement of subsequent trigger levels, the subsequent trigger levels corresponding to the accumulation of one or more predefined quantities of the incremented units.

42. The method of claim 37 including the step of multiplying the number of units to be incremented by the number of bet units.

43. The method of claim 37 wherein the number of incremented units is dependent upon the randomly selected game outcome.

44. The method of claim 37 including the step of redeeming the incremented units for credits, the number of credits determined by the number of incremented units redeemed.

45. The method of claim 37 including the step of redeeming the incremented units for an opportunity to play a feature game.

46. The method of claim 45 further including the step of paying a progressive prize awardable as a result of the feature game outcome.

47. The method of claim 37 further including the step of displaying an opportunity for the player to redeem the incremented units upon losing all wagerable credits.

48. The method of claim 37 further including the step of associating the incremented units with the player and saving the incremented units from one playing session to another.
